(19) United States
(12) Patent Application Publication
(10) Pub. No.: US 2010/0029266 A1
(43) Pub. Date: Feb. 4, 2010

(54) SYSTEM AND METHODS FOR QUALITY OF EXPERIENCE REPORTING

(75) Inventors: Jozef Pieter van Gassel, Tampere (FI); Imed Bouazizi, Tampere (FI); Igor Danilo Diego Curcio, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/496,230

(22) Filed: Jul. 1, 2009

Related U.S. Application Data
(60) Provisional application No. 61/077,868, filed on Jul. 2, 2008.

(51) Int. Cl. H04W 24/00

(52) U.S. Cl. 455/424

(57) ABSTRACT

In accordance with an example embodiment of the present invention, a method, comprising; verifying, by a user equipment, that one or more rules associated with a process of reporting quality of experience metrics are satisfied, said quality of experience metrics being associated with a multimedia telephony call; generating quality of experience metrics report, by the user equipment, according to configuration information related to the process of reporting quality of experience metrics if the rules associated with a process of reporting quality of experience method are satisfied; and sending the quality of experience metrics report to a server according to the configuration information, wherein the server is outside data links connecting the user equipment to at least another user equipment participating in the multimedia telephony service.

### RELATED APPLICATION

This application claims priority to U.S. Provisional Application No. 61/077,868 filed Jul. 2, 2008, which is incorporated herein by reference in its entirety.

### TECHNICAL FIELD

The present application relates generally to telecommunication services.

### BACKGROUND

Multimedia Telephony Service for IP Multimedia Subsystem (MTSI) is a multimedia telephony service standardized in Release 7 of 3^{rd} Generation Partnership Project (3GPP). MTSI is built according to the 3GPP standards IP Multimedia Subsystem (IMS). MTSI allows the delivering of advanced multimedia services and content over networks with IP technology.

MTSI supports conversational speech, video and text transported over Real-time Transport Protocol (RTP). The MTSI standard defines media handling and interactivity functions or procedures. Media handling comprises signaling, transport, jitter buffer management, packet-loss handling, adaptation, and/or the like. Interactivity comprises adding or dropping media during a call. One goal of MTSI is to achieve a user experience equivalent to or better than that of Circuit Switched (CS) conversational services while using the same amount of network resources. Another goal is to ensure a reliable and interoperable service with a predictable media quality, while allowing for flexibility in the service offerings.

### SUMMARY

Various aspects of the invention are set out in the claims.

In accordance with an example embodiment of the present invention, an apparatus, comprising; a memory unit configured to store configuration information related to a process of reporting quality of experience metrics to a server, the quality of experience metrics being associated with a multimedia telephony call, and the server is outside data links, connecting the apparatus to at least one user equipment associated with the multimedia telephony call; and a processor communicatively connected to said memory unit. The processor is configured to verify that one or more rules associated with the process of reporting quality of experience metrics are satisfied, generate quality of experience metrics report according to the configuration information related to the process of reporting quality of experience metrics if the rules associated with a process of reporting quality of experience method are satisfied and to send the quality of experience metrics report to a server according to the configuration information.

In accordance with another example embodiment of the present invention, a method, comprising; verifying, by a user equipment, that one or more rules associated with a process of reporting quality of experience metrics are satisfied, said quality of experience metrics being associated with a multimedia telephony call; generating quality of experience metrics report, by the user equipment, according to configuration information related to the process of reporting quality of experience metrics if the rules associated with a process of reporting quality of experience method are satisfied; and sending the quality of experience metrics report to a server according to the configuration information, wherein the server is outside data links connecting the user equipment to at least another user equipment participating in the multimedia telephony service.

In accordance with another example embodiment of the present invention, an apparatus comprising a memory unit and a processor communicatively connected to the memory unit. The processor is configured to determine whether to update configuration information related to a process of reporting quality of experience metrics, stored in at least one user equipment, and to send, to at least one user equipment, updates of the configuration information related to the process of reporting quality of experience metrics, if one or more updates are determined to be required.

In accordance with another example embodiment of the present invention, a method, comprising; determining whether to update configuration information related to a process of reporting quality of experience metrics, stored in at least one user equipment, and sending, to at least one user equipment, updates of the configuration information related to the process of reporting quality of experience metrics, if one or more updates are determined to be required.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 is an overview diagram illustrating call set-up signaling and media path for MTSI;

FIG. 2 is an overview diagram illustrating a system according to an example embodiment of the present invention;

FIG. 3 is a flow chart of a method for reporting QoE metrics according to an example embodiment of the present invention;

FIG. 4 illustrates an example structure of a management object with information related to QoE metrics reporting;

FIG. 5 illustrates another example structure of a management object with information related to QoE metrics reporting; and

FIG. 6 is a flow chart of a method for receiving QoE metrics reports according to an example embodiment of the present invention.

### DETAILED DESCRIPTION OF THE DRAWINGS

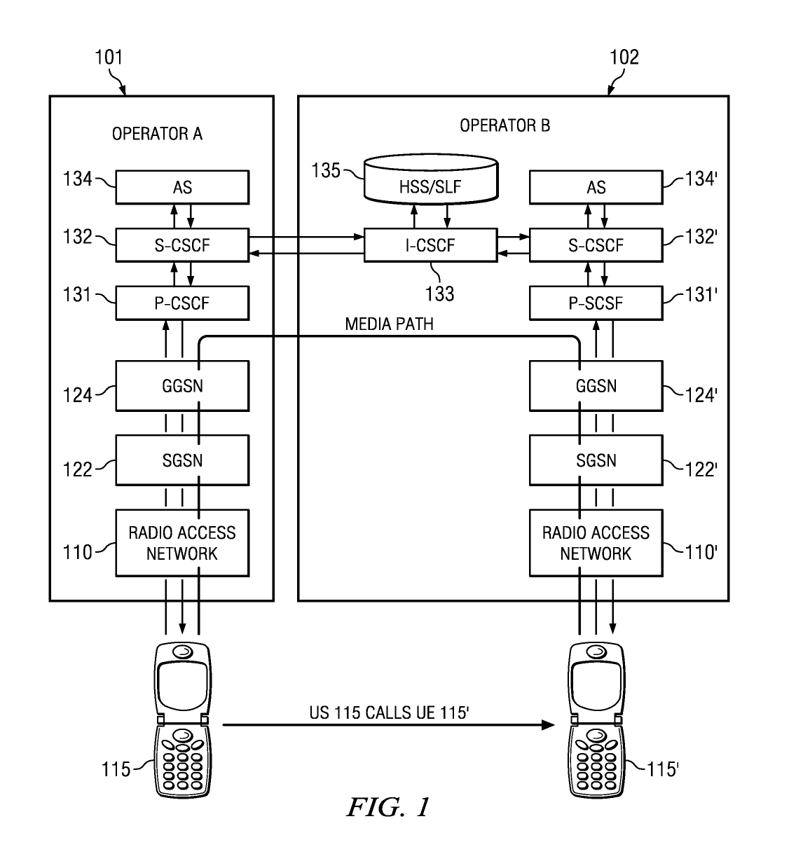

An example embodiment of the present invention and its potential advantages are best understood by referring to FIGS. 1 through 6 of the drawings, like numerals being used for like and corresponding parts of the various drawings.

FIG. 1 is an overview diagram illustrating call set-up signaling and media path for MTSI. A MTSI call may use Call Session Control Function (CSCF) mechanisms to route control-plane signaling between the UEs involved in the call In an example, a user equipment (UE) 115 having access to a radio access network (RAN) 110 initiates a multimedia telephony service session by calling at least another UE 115′. In an example embodiment, UE 115 is connected to a network 101 associated with operator A and UE 115′ is connected to a network 102 associated with operator B.

In one example, control-plane signaling is forwarded, e.g., via a Session Initiation Protocol (SIP) invite message, from the RAN 110 to a Core Network (CN), where control-plane signaling is routed through a Serving GPRS Support Node (SGSN) 122 and a Gateway Generic Packet Radio Services (GPRS Support Node (GGSN) 124 to an IMS. In the IMS, the control-plane signaling is routed through CSCF modules comprising a Proxy Call Session Control Function (P-CSCF) 131, a Serving Call Session Control Function (S-CSCF) 132, and an Interrogating Call Session Control Function (I-CSCF) 133. At the I-CSCF, location may be known by Subscriber Location Function (SLF) and/or Home Subscriber Function (HSS) 135. In the control plane, Application Servers (AS), e.g. 134 and 134′, may provide supplementary services such as call hold/resume, call forwarding, multi-party calls, and/or the like. In the network 102, control-plane signaling is routed through a GGSN 124′ and a SGSN 122′ and transmitted through RAN 110′ to UE 115′. Control-plane signaling may also include signals, e.g., acknowledgements, from the called UE 115′ to the caller UE 115.

Further, media data may not comprise the same path as control-plane signaling. Media data transmitted, for example, from UE 115 to UE 115′ is routed through the RAN 110, the SGSN 122 and the GGSN 124 associated with UE 115 and then through the GGSN 124′, the SGSN 122′, and the RAN 110′ associated with UE 115′. Data may be transported using Transmission Control Protocol (TCP) or User Datagram Protocol (UDP).

In one example embodiment UEs, 115,115′, participating participate in the same call may be in the same network, e.g., same operator. In another embodiment, the UEs 115 and 115′ participating in the same call may be accessing different networks corresponding to different operators. Examples of acces networks to which UEs 115, 115′ may be connected comprise RAN, internet, an intranet, a local area network a fixed-line phone network, and/or the like. Further, UEs 115, 115′ may have a wired or wireless connection to an acces network. UEs 115, 115′ may also comprise a lap top, a desk top, a mobile phone, a phone connected to a fixed phone line, and/or the like.

In an example, MTSI services may comprise transfer, across one or more networks, of real-time full-duplex speech, real-time video, text communication, data files, and or the like. The quality of experience as perceived by a customer, e.g., a phone user consuming an MTSI service, may become unacceptable due, for example, to a network congestion and/or data packet loss. Currently in 3GPP MTSI, there is no support for a Quality of Experience (QoE) reporting mechanism to allow feedback, from users, regarding quality of service (QoS).

In an example embodiment, a QoE metric framework is a provisioning to assess the experience of an end user of media streaming applications. The QoE metric framework enables a combination of cross-layer measurements and extracting results (QoE metrics). The extracted results may be used to monitor and improve the end user experience over severely variable network conditions. In an example embodiment of the present invention, a 3GPP MTSI client supporting a QoE metric feature may perform one or more quality measurements. The quality measurements relate to QoE metrics for MTSI sessions. Examples of QoE metrics comprise changes in transmission or reception bitrates, requests for intra refresh frames, service interruptions and/or lengths of interruptions, picture freezing and/or freezing length, change of codec selections, e.g., payload types, packet loss rates indicated by one or more participants, and/or the like. The client may aggregate the measurements into client QoE metrics. The client reports the metrics to a metrics report server using a QoE transport protocol.

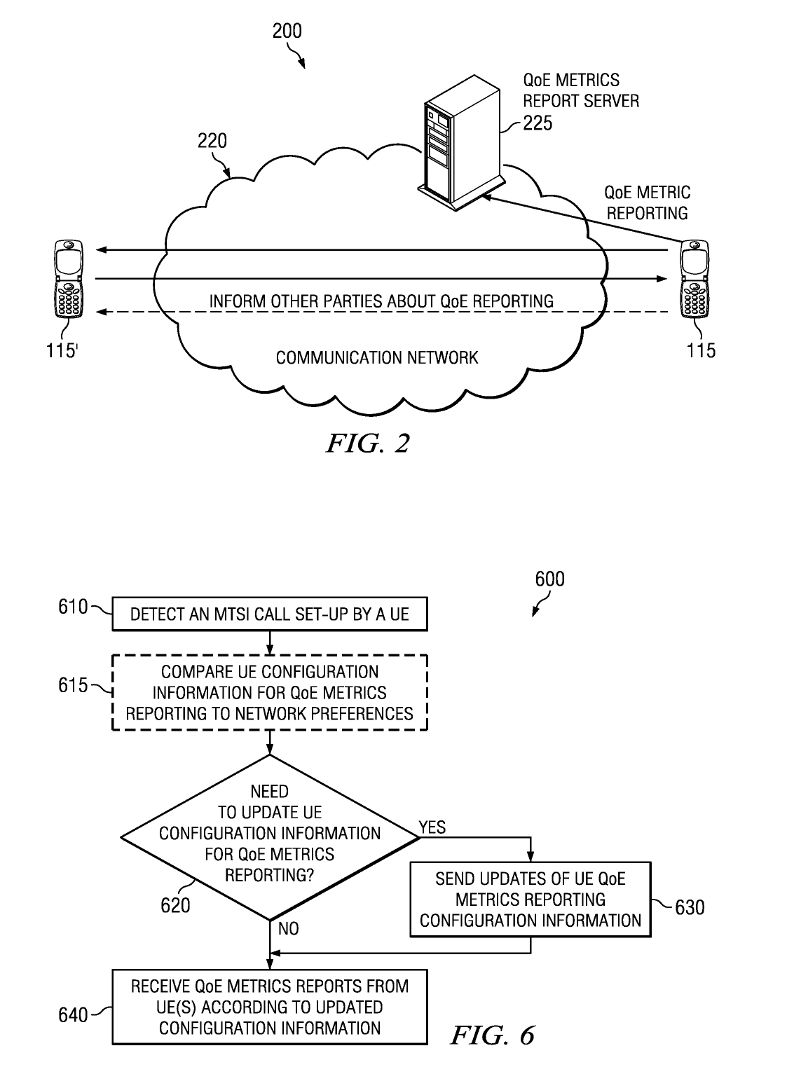

FIG. 2 is an overview diagram illustrating a system 200 according to an example embodiment of the present invention. In this example embodiment, the system 200 may comprise a communication network 220, a QoE metrics report server 225 and one or more user equipments 115, 115′, connected through wired and/or wireless links to the communication network 220. The communication network 220 may be a network associated with one operator, multiple networks associated with one or more operators, and/or the like. In an example embodiment, the communication network comprises an Internet Protocol (IP) Multimedia Subsystem IMS.

In an embodiment, the system 200 comprises a data link, e.g., a bi-directional end-to-end link between the calling parties UE 115 and UE 115′. The example embodiment, may further comprise the QoE metrics reports, which are not exchanged between the end-point clients, or UEs, e.g., 115 and 115′. In an embodiment, the QoE metrics reports may be transmitted from one or more end-point clients to a QoE metrics report server 225. In an example embodiment, the QoE metrics report server 225 may a logical entity residing in a network servernetwork node and/or the like. For example, the QoE metrics report server may be residing in application server, e.g., 134 and 134′. In another an alternative example embodiment, the QoE metrics report server 225 may be a computer server associated with a network provider. As shown in FIG. 2, the QoE metrics report server 225 is outside the data link, e.g., bi-directional data link, between the end-point clients or UEs 115 and 115′.

In an example embodiment of the invention, configuration information for reporting QoE metrics may be used, for example, to control whether the QoE metrics reporting is used, to set rules for QoE metrics reporting, e.g., related to timing of reporting, frequency of reporting, reporting entity and/or the like, to identify receiving entity of QoE reports, and/or the like.

In one example embodiment of the present invention, SIP signaling for setting up calls and or sessions may be used to initiate a QoE metrics reporting function. In this embodiment the set of QoE metrics to be sent from an MTSI client to the QoE metrics report server may be negotiated during the call setup. For example, the syntax and semantics of Session Description Protocol (SDP) attribute, e.g., “3GPP-QoE-Metrics”, may be used for QoE metrics negotiation. In an alternative embodiment, the Real-Time Streaming Protocol (RTSP) header extension, e.g., “3GPP-QoE-Metrics”, may be used as a SIP header extension in order to negotiate the QoE metrics to be sent to the server. For example, the SDP may be carried in the body of the SIP request. In this way, the negotiation of the QoE metrics is a part of media negotiation process of the call setup.

In the negotiation of the QoE metrics, the negotiating parties comprise one or more UEs, e.g., MTSI clients or SIP User agents (UA), and the QoE metrics collection entity, e.g., the QoE metrics report server 225, in the communication network 220. In one embodiment, the QoE metrics report server 225 may have access to, or may be on, the control-plane signaling path described in FIG. 1. Furthermore, one or more SIP Proxies may be required to insert and interpret the header fields, e.g., associated with QoE metrics reporting, during the call setup process.

In another example embodiment, the network operator may indicate its preferences for the QoE metrics reporting using an Open Mobile Alliance (OMA) Device Management (DM) Management Object (MO). An OMA DM MO, e.g. a 3GPP MTSI Network Preference (MTSINP) MO, may be used to manage settings which express the network preference for the MTSI client in the terminal, or UE. A QoE management objects, having information associated with QoE metrics reporting, may be defined as an interior node of the OMA DM MO, or 3GPP MTSINP MO. The QoE MO may be used to manage QoE metrics, rules for reporting the QoE metrics, the QoE server 225, and/or the like information associated with reporting QoE metrics. In one example implementation, a UE 115, 115′, may report the QoE metrics specified in QoE MO, to the QoE metrics report server 225, in a best-effort manner case. According to this example implementation, no QoE metrics negotiation takes place between UE 115, 115′, and QoE metrics report server 225. In an alternative embodiment, the QoE MO may be used to signal the preferred reporting metrics and rules, and the final configuration may be negotiated between UE 115, 115′, and the QoE metrics report server 225 using SIP and/or SDP.

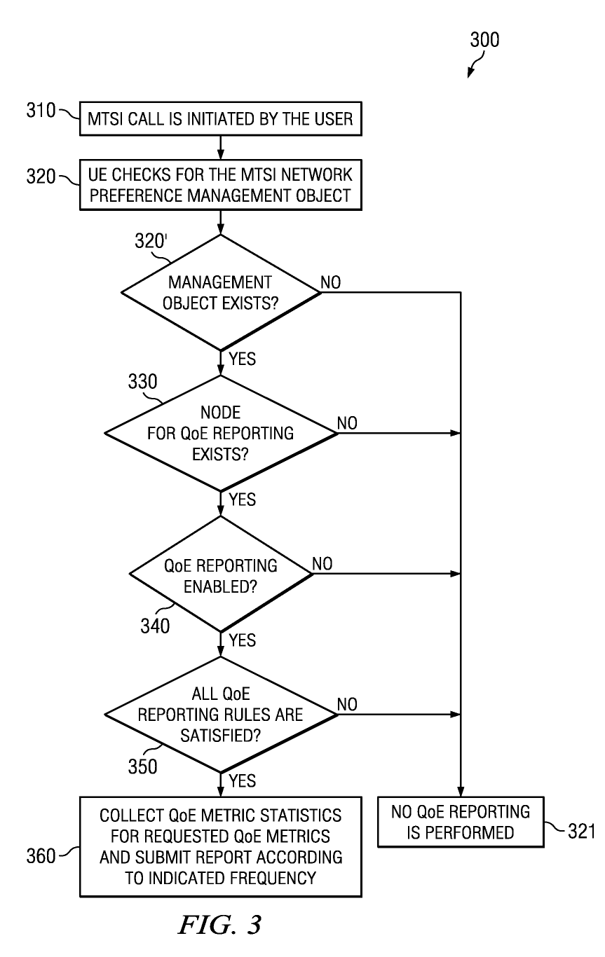

FIG. 3 is a flow chart of a method 300 for reporting QoE metrics according to an example embodiment of the present invention. The method 300 in this embodiment is performed by a UE, 115, 115′. At block 310, an MTSI call is initiated by UE 115, 115′. At block 320, UE 115, 115′, checks for MTSINP MO. A decision is made at block 220′ based on whether or not the MTSINP MO exists. If the MTSINP MO exists, then at block 330, the UE 115, 115′, fetches the MTSINP MO to check whether it has a QoE node. According to this example embodiment, one or more QoE MOs may be defined as interior nodes, e.g., subtree, of the MTSINP MO. If a QoE node exists in the MTSINP MO, the UE 115,115′, checks, at block 340, whether or not QoE reporting is enabled in at least one of the one or more QoE MOs. If QoE reporting is enabled in at least one QoE MO, then at block 350 the UE 115 verifies whether all reporting rules, associated with the at least one QoE MO, are satisfied. If all the rules are satisfied then at block 360 the UE 115, 115′, prepares a report comprising QoE metrics' values, e.g., metrics measurements, statistics, and/or the like, to be reported to the QoE metrics report server 225. For example, the UE 115, 115′, may take one or more measurements at block 360 and/or extract QoE metrics measurements, statistics, and or the like stored in a meory unit. The UE 115, 115′, transmits the QoE metrics report to the QoE metrics report server 225 according to, for example, timing, frequency, format, and/or the like rules indicated in the at least one QoE MO. In the case where the answer is no in one of the blocks 320′, 330, 340 and 350, then at block 321 the UE, e.g., 115 and/or 115′, decides not to report QoE metrics.

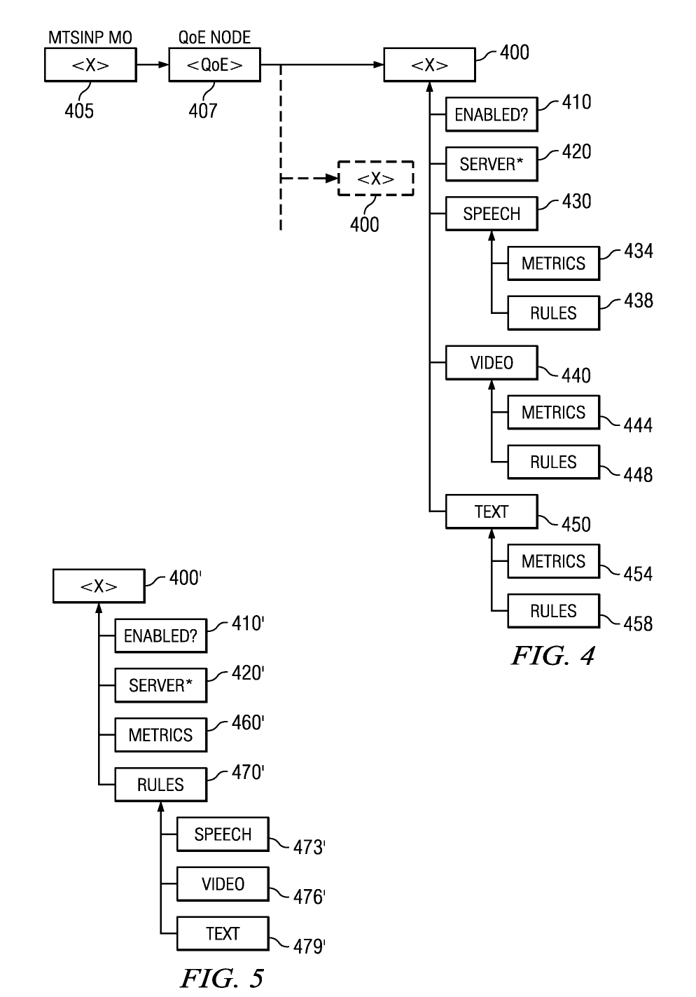

FIG. 4 illustrates an example structure of a QoE management object 400. According to an example embodiment of the present invention, an interior node, e.g., a QoE node 407, to the MTSINP MO 405 is defined in order to store the network preferences with regards to the QoE reporting. The QoE node 407 may have one or more QoE management objects 400 connected to it as subtrees. The one or more QoE management objects 400 carry information associated with QoE metrics reporting configuration as requested by one or more network operators. In an example embodiment, a QoE management objects 400 groups, or carries, QoE metric reporting configuration information associated with a specific network operator. According to this embodiment, each network operator may set its own preferences for QoE metrics reporting. In the example of FIG. 4, the QoE management object 400 comprises an enabled flag node 410, a server node 420, and separate nodes for media components, e.g., types of media content, comprising a speech node 430, a video node 440 and a text node 450. The enabled flag node 410 comprise and indicator, for example of Boolean type, to indicate whether the the QoE metrics reporting configuration associated with the same parent QoE management object 400, of the enabled flag node 410, are enabled or not. The server node 420 has information about a network entity or server receiving QoE metrics reports, e.g., QoE metrics report server 225. For example, the server node may contain a URL for the server(s) to which the QoE reports are sent. In case of multiple servers, a random selection process may be used. Alternatively a single server may be assigned to (all) calls of a UE by modifying the server node for every UE, e.g., 115 and/or 115′, separately.

In the example embodiment of FIG. 4, each of the nodes speech 430, video 440 and text 450 comprises one metrics leaf, 434, 444, and 454, and one rules leaf, 438, 448, and 458. Each metrics leaf, 434, 444, and 454, describes the QoE metrics associated with the corresponding content type. The metrics leaf, e.g., 434, 444, and 454, provides the requested QoE metric reporting configuration. It provides, for example, in textual format the QoE metrics that need to be reported. It may also provide reporting frequency. In the example of FIG. 4, metrics leaf 434 may have a list of one or more QoE metrics related to speech content, metrics leaf 444 may have a list of one or more QoE metrics related to video content, and metrics leaf 454 may have a list of one or more QoE metrics related to text content. According to the same example, rules leaf 438 may have a list of one or more rules associated with reporting QoE metrics related to speech content, rules leaf 448 may have a list of one or more rules associated with reporting QoE metrics related to video content, and rules leaf 458 may have a list of one or more rules associated with reporting QoE metrics related to text content. The rules leaf, 438, 448 and 458, may provide in textual format how and when the metrics are expected to be reported to the QoE metrics report server 225.

FIG. 5 illustrates another example structure of a QoE management object 400′. Similar to the example in FIG. 4, the QoE management object 400′ of FIG. 5 has an enabled flag node 410′ and a server node 420′. The QoE management object 400′ of FIG. 5 has a metrics node 460′. According to this example, a single list of QoE metris may be defined, or specified, for all media components. The QoE management object 400′ also comprises a rules node 470′. The rules node 470′ comprises leaves associated with different media components. For example, sppech leaf 473′ comprises one or more rules associated with reporting QoE metrics related to speech content, video leaf 476′ comprises one or more rules associated with reporting QoE metrics related to video content, and text leaf 479′ comprises one or more rules associated with reporting QoE metrics related to text content. The examples of FIG. 4 and FIG. 5 are not exhaustive and other structures of the QoE management object may be possible.

An example format description of some of the described nodes is as follows;

/<X>/QoE
Occurrence: ZeroOrOne
Format: Node
Access Type: Get, Add
Value: N/A
/<X>/QoE/<x>
Occurrence: ZeroOrMore
Format: Node
Access Type: Get, Add
Value: N/A
/<X>/QoE/<x>/Enabled
Occurrence: One
Format: Bool
Access Types: Get, Replace
/<X>/QoE/<x>/Server
Occurrence: ZeroOrMore
Format: Char
Access Types: Get, Replace, Add
/<X>/QoE/<x>/APN
Occurrence: ZeroOrOne
Format: Chr
Access Types: Get, Replace, Add
/<X>/QoE/<x>/Metrics
Occurrence: ZeroOrMore / ZeroOrOne
Format: Char
Access Types: Get, Replace, Add
/<X>/QoE/<x>/Rules
Occurrence: ZeroOrMore
Format: Char
Access Types: Get, Replace, Add

In an example implementation, the syntax of the QoE metrics reporting rules may be similar to the syntax of the SDP attribute “3GPP-QoE-Metrics”. In another example embodiment, the syntax of the QoE metrics reporting rules may be integrated within within the /<X>/QoE/<X>/Metrics node, or leaf.

FIG. 6 is a flow chart of a method 600 for receiving QoE metrics reports according to an example embodiment of the present invention. At block 610, a network entity, e.g. QoE metrics report server 225, detects or becomes aware of a call set-up for a multimedia telephony service by a UE 115. For example, information related to the call set-up may be received by the QoE metrics report server 225 from a network element associated with a network provider. At block 620, the QoE metrics report server decides whether there is a need to update the configuration information for QoE metrics reporting stored in at least one UEs 115. The decision may be, as depicted in the optional block 615, based on a comparison of the UE configuration information for QoE metrics reporting with network preferences for QoE metrics reporting. If configuration information needs to be updated, then QoE metrics report server 225 sends an update of the configuration information, at block 630, to at least one UE 115. In one example embodiment, if configuration information for reporting QoE metrics is stored in a QoE management object, a network element, e.g., QoE metrics report server, may make the update by performing OMA DM management operations on the OMA DM MO stored in the UE 115. At block 640, whether there is no need for an update of UE configuration information or an update was already sent, the QoE metrics report server receives QoE metrics reports from a UE 115 according to updated UE configuration information for QoE metrics reporting. In another embodiment, the UE 115 may receive a new OMA DM MO, or a QoE management object, at any time during an active call.

In yet another example embodiment, the UE 115 and/or 115′ may roam to another network during a call. In this case a QoE metrics reporting server associated with the new visited network may have to push a new OMA DM MO, or a QoE management object, to the UE 115 and/or 115′. Upon receiving the management object, the UE ceases reporting QoE metrics to the old network and start reporting the QoE metrics to the new QoE metrics report server 225, e.g., in the new visited network, as indicated in the new management object.

In an example embodiment where QoE metrics report server 225 may receive QoE metrics reports from the called UE(s) 115′, the caller UE 115′ may forward configuration information for QoE metrics reporting using SDP containing the “3GPP-QoE-Metrics” attribute to the called UE(s) 115′. It may also be necessary to inform other parties of the call that QoE metric reporting is being done on this call. The SDP is embedded in the original SIP INVITE message, or alternatively in a SIP UPDATE method. For this case, QoE metrics reporting initiation procedure may comprise:
1) Operator sends an OMA DM MO to one of the MTSI UEs, for example the calling UE 115
2) The MTSI UE 115 that received the OMA DM MO uses SIP+ SDP to signal to the called UE(s) 115′ the requested set of metrics in the OMA DM MO. The caller UE 115 acts as forwarder. The caller UE 115 may forward the same information to other future participants, in case new parties join in the call, for example in a multi-party call scenario. If the caller UE 115 leaves the call, before leaving the call it may send a forwarder token to one of the remaining active UE(s), in order to act as forwarder in the future.
3) The metrics are reported by the UE(s) to the reporting server via HTTP Post.

In an example embodiment of a multi-party call, e.g., a conferencing session, if one or more UE(s) join after the session starts, the QoE metrics reporting initiation information may be forwarded to the one or more UE(s) as they join the session. In a multi-party call, the arrival and departure of participants may be handled, in light of QoE metrics reporting in a conferencing scenario, based on the conferencing model used. For example, in loosely coupled conferences, conference participation is gradually learned through control information that is passed as part of the conference, e.g., using RTCP. Hence there is no SIP signalling relationship between participants and QoE metrics initiation information may be distributed out-of-band (not using RTCP), e.g., in an SDP of a multicast media session. In fully distributed multi-party conferences every participant is in a SIP dialog with every other participant. On setup or teardown of calls, information about QoE metrics reporting initiation may be exchanged, e.g., in INVITE and/or UPFATE SIP message(s). Within the scope of 3GPP, tightly coupled conferences are used. In tightly coupled conferences, the “focus”, e.g., one participant, of the conference is in a SIP dialog with all participants and can therefore take the role of distributing information related to QoE metrics reporting initiation, e.g., in INVITE and/or UPFATE SIP request(s).

Within the scope of 3GPP tightly coupled conferences are used [6] and therefore this model is relevant for the QoE metrics reporting. As mentioned above the departure and arrival of participants is handled by the focus entity which is the central component in the conference.

A dialog as defined in RFC 3261 [7] is a peer-to-peer SIP relationship between two UAs that persists for some time (established by SIP messages). The focus as defined in RFC 4353 [8] is a logical role of a SIP user agent that is addressed by a conference URI and identifies a conference. The focus maintains a SIP signalling relationship with each participant in the conference.

It should be noted that many other variations of the tree structure are possible without changing the essence of the invention. In particular “Ext” (Extension) leaves may be added to allow for future extensions in the tree structure. Furthermore Metrics and Rules leaves may also be inserted at the root level (e.g. “/<X>/Metrics” and “/<X>/Rules”) in order to provide default values for different media components of the MTSI session. These Metrics and Rules may subsequently be overridden at the media component level. Furthermore the separate speech, video and test nodes or leaves may be entirely omitted when the same rules and metrics are applied to all media components of the call.

QoE reporting rules may be used to control the amount of QoE metrics reports sent to the OoE metrics report server 225, for example, to prevent server overload. Examples of QoE reporting rules, and their syntax and semantics comprise;

### Send Only Caller Reports to the Reception Server (ReportingSource/OnlyCallerReports)

This rule is used to determine the QoE metrics reporting sources. This could either be all participants in the call, or only the UE that is the initiator, e.g., caller, of the call. A parameter source is used to signal whether all (source=“all”) or just the caller (source=“caller_only”) reports QoE metrics. Further extensions of the possible reporting sources are possible. In an another embodiment, this rule, e.g., renamed as OnlyCallerReports, may be signalled without parameters. In this case, the absence of this flag, e.g., OnlyCallerReports, may signal that caller UE 115 and called UE(s) 115′ report QoE metrics.

### Send Reports for Every Nth Call Made by the UE (SubsampleSessions)

In this case N is a parameter, e.g., subsample_factor, to determine the frequency of reporting QoE metrics. This means (subsample_factor−1) calls may be skipped before the next call requires reporting of QoE metrics.

### Send Reports for at Maximum M Calls Per Time Unit (LimitSessionRate)

For this rule one or two parameters may be used. The first parameter max_sessions indicates the maximum number M of calls for which to report QoE metrics within a specified time unit. Optionally the time_unit parameter specifies the length of the time unit, e.g., in seconds. The default value for this parameter may be 1 second. This optional parameter may be completely discarded from the syntax if a default value is acceptable in all cases. For example, max_sessions=5 and time_unit=1 requires to report at most 5 calls in a time period of one second. Another example is max_sessions=5 and time_unit=3600, which indicates to report QoE metrics for maximum 5 calls in a time period of one hour. In the absence of this rule reporting for each call may be required.

### Send Reports at Minimum Time Interval T Per Time Unit (LimitSessionInterval)

This rule determines the minimum time interval T between any two calls with QoE metrics reporting. In one example implementation, a single parameter, e.g., min_interval, which indicates the minimum time distance between the start, or end, of two successive calls that report QoE metrics within a specified time unit. Optionally the second time_unit parameter specifies the length of the time unit (in seconds). The default value for this parameter is 1 second. This optional parameter can be completely discarded from the syntax if a default value of 1 second is acceptable in all cases. For example min_interval=5 and time_unit=60 requires the time distance of two successive calls that report metrics to be at least 5 minutes apart.

### Probability Based Reception Reporting Decision Per Call (RandomizeSessions)

The parameter reporting_probability indicates the percentage of calls that require QoE metrics reporting. In one example implementation, the UE may generate a number ranging from 0-100 according, for example, to a uniform probability density function. Depending on whether the generated value exceeds the threshold given by the reporting_probability parameter, the QoE metrics reporting, e.g., the enabled flag in the QoE management object, may be switched off or on.
   Note that names of the rules and parameters may be chosen differently without changing the semantics of the rule definitions.

In an example embodiment, negotiation of QoE metrics reporting rules, between QoE metrics report server 225 and UE(s) 115 and/or 115′, may take place, for example, after retrieving the initial rules from the OMA DM MO. QoE metrics reporting rules negoation may be performed using SIP header fields and/or SDP attributes during call setup process. In this example embodiment, syntax similar to that of SIP header fields and/or SDP attributes may be used in defining, or describing, QoE metrics reporting rules and configuration information related to QoE reporting in general. For example, a basic structure of the rule syntax may consist of three major parts; the header field/attribute name (e.g., “3GPP-QoE-Rule”), the name of the specific rule and an optional list of parameters for that rule. The following notation is an example rule syntax:

| | | |
|---|---|---|
| Rule | = | “3GPP-QoE-Rule” “:” 1*(rule-spec) |

| | | |
|---|---|---|
| rule-spec | = | rule-name [“;” parameters] |
| rule-name | = | “OnlyCallerReports” \| “SubsampleSessions” \| |
| | | “LimitSessionRate” \| “LimitSessionInterval” \| |
| | | “RandomizeSessions” \| ... |
| parameters | = | parameter *(“;” parameter) |

| | |
|---|---|
| parameter = | name [“=” value ] |

where name and value may be arbitrary string denoting the name of the parameter and the value respectively.
For example:
3GPP-QoE-Rule: LimitSessionRate; max_sessions=5; time_unit=3600
   In this example at maximum five calls, or sessions, may report QoE metrics to the server per hour for a particular UE 115.

Note that alternative embodiments may be using XML or binary representations of the metrics reporting rules without changing the concept of applying metrics rules.

In case specific rules need to be assigned to a single metric, the syntax may be changed in such a way that the rule definition be be appended to the existing “3GPP-QoE-Metrics” SIP header field and/or SDP attribute. It may also be useful to combine more than one rule. For example “3GPP-QoE-Rule” element may either be added multiple times or the syntax may be changed in such a way that it allows multiple rules to be aggregated into a single syntactical element. As an illustrating example, the OnlyCallerReports rule may be used in combination with other rules. Other possible combinations may be useful too.

In an example embodiment, HTTP POST procedure, used in Multimedia Broadcast/Multicast Services (MBMS) may be used for the delivery of the QoE metrics reception reports. In this example embodiment, a XML description containing the metrics will be transmitted directly to the metrics collecting server using HTTP POST. Note that in 3GPP MBMS standard “post-reporting” is defined. For post-reporting in MTSI a similar scheme as in MBMS standard may be used. For the MTSI case, the XML scheme used in the body of the HTTP POST request may be extended to allow for delivery of intermediate, e.g., during the call, QoE metrics reports. Furthermore, the XML scheme may be extended to include timing information and session identification. An example of an XML Schema for the intermediate reception reports may be defined as follows:

```
<?xml version=“1.0” encoding=“UTF-8”?>
<xs:schema xmlns:xs=“http://www.w3.org/2001/XMLSchema” ...>
<xs:element name=“receptionReport” type=“receptionReportType”/>
<xs:complexType name=“receptionReportType”>
    <xs:sequence>
    <xs:complexType name=“qoeMetricsType”>
          <xs:sequence>
            <xs:any namespace=“##other” processContents=“skip”
minOccurs=“0”
                maxOccurs=“unbounded”/>
          </xs:sequence>
      <xs:attribute name=“timeStamp” type=“ xs:double ”
      use=“required”/>
        <xs:attribute name=“corruptionDuration”
type=“xs:unsignedLong” use=“optional”/>
        <xs:attribute name=“t” type=“xs:boolean” use=“optional”/>
        <xs:attribute name=“rebufferingDuration” type=“xs:double”
use=“optional”/>
        <xs:attribute name=“initialBufferingDuration” type=“xs:double”
use=“optional”/>
        <xs:attribute name=“numberOfSuccessivePacketLoss”
type=“xs:unsignedLong”
              use=“optional”/>
        <xs:attribute name=“framerateDeviation” type=“xs:double”
use=“optional”/>
        <xs:attribute name=“jitterDuration” type=“xs:double”
use=“optional”/>
          a. <xs:anyAttribute processContents=“skip”/>
    </xs:complexType>
    </xs:sequence>
    <xs:attribute name=“sessionID” type=“xs:string” use=“required”/>
</xs:complexType>
</xs:schema>
```

This schema definition also allows aggregation of different metrics into a single XML description. This reduces overhead arid minimizes the number of HTTP POST requests required for the metrics reporting.

In a different embodiment, the QoE metrics are represented as XML elements, e.g., instead of attributes, with a separate timestamp attribute per metrics XML element. In this schema, the syntax of the “timeStamp” attribute is based on the NTP time format, e.g., a floating point value with a seconds and fraction part. The session identification of the metrics reception report consists of a string with the “To”, “From” and “Call-ID” SIP Header fields in order to uniquely identify the call. In addition it may be required to identify a certain RTP Session within the call, e.g. audio, video or text RTP stream. In a different embodiment these three SIP header fields can be represented by separate XML elements or attributes. The metrics reporting server itself is identified through the OMA DM Management Object described in the previous section.

In case no QoE reporting is desirable, this may be signaled by the QoE metrics report server 225, to the UE 115, 115′, by sending an error code in its HTTP response, e.g., in addition to the other rules mechanism presented in the previous section. This may be useful in case the reception report server gets temporarily overloaded with reception reports, e.g., by different clients at the same time.

The use of the SIP, SDP, XML, HTTP, OMA DM MO protocols is not restrictive for this invention, and that the same information could be transmitted via other protocols at any of the layers of the ISO OSI protocol stack and via wireless and wired network connections between the entities (also via proxies and gateways).

Without in any way limiting the scope, interpretation, or application of the claims appearing below, it is possible that a technical advantage of one or more of the example embodiments disclosed herein may be assessing quality of experience by users. Another possible technical advantage of one or more of the example embodiments disclosed herein may be emproving quality of service in multimedia phone telephony. Another technical advantage of one or more of the example embodiments disclosed herein may be preventing overloading of QoE metrics reprt server 225.

Embodiments of the present invention may be implemented in software, hardware, application logic or a combination of software, hardware and application logic. The software, application logic and/or hardware may reside on a server, mobile device, a computer or a laptop. If desired, part of the software, application logic and/or hardware may reside on server, part of the software, application logic and/or hardware may reside on mobile device or a computer, and part of the software, application logic and/or hardware may reside on chipset. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a memory unit configured to store configuration information related to a process of reporting quality of experience metrics to a server, said quality of experience metrics being associated with a multimedia telephony call, and said server being outside data links connecting the apparatus to at least one user equipment associated with the multimedia telephony call; and
a processor communicatively connected to said memory unit, said processor configured to;
verify that one or more rules associated with the process of reporting quality of experience metrics are satisfied;
generate quality of experience metrics report, by said user equipment, according to said configuration information related to the process of reporting quality of experience metrics if said rules associated with the process of reporting quality of experience method are satisfied; and
cause the apparatus to send said quality of experience metrics report to a server according to said configuration information.

2. An apparatus according to claim 1, wherein said configuration information is stored in a management object.

3. An apparatus according to claim 1, wherein said configuration information comprises one or more of:
information related to a quality of experience metrics report server, said server receiving quality of experience metrics reports;
a list of one or more quality of experience metrics;
said one or more rules associated with a process of reporting quality of experience metrics; and
indication on whether quality of experience metrics reporting is requested.

4. An apparatus according to claim 1, wherein said processor is further configured to cause the apparatus to receive updates of said configuration information.

5. An apparatus according to claim 1, wherein said processor is further configured to cause the apparatus to send said configuration information to one or more other user equipments participating in the multimedia telephony call.

6. A method, comprising:
verifying, by a user equipment, that one or more rules associated with a process of reporting quality of experience metrics are satisfied, said quality of experience metrics being associated with a multimedia telephony call;
generating quality of experience metrics report, by said user equipment, according to configuration information related to the process of reporting quality of experience metrics if said rules associated with the process of reporting quality of experience method are satisfied; and
sending said quality of experience metrics report to a server according to said configuration information, wherein said server being outside data links connecting the user equipment to at least another user equipment participating in the multimedia telephony service.

7. A method according to claim 6, wherein said configuration information is stored in management object.

8. A method according to claim 6, wherein said configuration information comprises one or more of:
information related to a quality of experience metrics report server, said server receiving quality of experience metrics reports;
a list of one or more quality of experience metrics;
said one or more rules associated with a process of reporting quality of experience metrics; and
indication on whether quality of experience metrics reporting is requested.

9. A method according to claim 6, further comprises receiving updates of said configuration information.

10. A method according to claim 6, further comprising sending said configuration information to one or more other user equipments participating in the multimedia telephony call.

11. An apparatus comprising:
a memory unit;
a processor communicatively connected to said memory unit, said processor configured to;
determine whether to update configuration information related to a process of reporting quality of experience metrics, stored in at least one user equipment; and
to cause the apparatus to send, to at least one user equipment, updates of said configuration information related to said process of reporting quality of experience metrics.

12. An apparatus according to claim 11, wherein said processor is further configured to detect a multimedia telephony call set-up.

13. An apparatus according to claim 11, wherein said at least one update is a management object.

14. An apparatus according to claim 11, wherein said configuration information comprises one or more of:
information related to a quality of experience metrics report server, said server receiving quality of experience metrics reports;
a list of one or more quality of experience metrics;
said one or more rules associated with a process of reporting quality of experience metrics; and
indication on whether quality of experience metrics reporting is requested.

15. A method, comprising:
determining whether to update configuration information related to a process of reporting quality of experience metrics, stored in at least one user equipment; and
sending, to at least one user equipment, updates of said configuration information related to said process of reporting quality of experience metrics.

16. A method according to claim 15, further comprising detecting a multimedia telephony call set-up.

17. A method according to claim 15, wherein said at least one update is a management object.

18. A method according to claim 15, wherein said configuration information comprises one or more of:
information related to a quality of experience metrics report server, said server receiving quality of experience metrics reports;
a list of one or more quality of experience metrics;
said one or more rules associated with a process of reporting quality of experience metrics; and
indication on whether quality of experience metrics reporting is requested.
